(19) United States
(12) Patent Application Publication
(10) Pub. No.: US 2006/0179323 A1
(43) Pub. Date: Aug. 10, 2006

(54) Method for substitution of prompts for an encrypting pin device

(75) Inventor: ChuChing Nei, Los Altos, CA (US)

Correspondence Address: OLIFF & BERRIDGE, PLC, P.O. BOX 19928, ALEXANDRIA, VA, 22320, US

(73) Assignee: XAC AUTOMATION CORP., Hsinchu (TW)

(21) Appl. No.: 11/049,700

(22) Filed: Feb. 4, 2005

(51) Int. Cl. H04K 1/00

(52) U.S. Cl. 713/184

(57) ABSTRACT

After receiving a general display command, an encrypting PIN device recognizes whether the received command corresponds to an expected prompt stored in the device. Afterward, an approved prompt is substituted for the expected prompt, and is displayed by the encrypting PIN device. On the contrary, the received prompt that is not recognized as an expected prompt is displayed without the ability for numeric input while being displayed.

### BACKGROUND OF THE INVENTION

1. Field of the Invention

The present invention relates to a method for substitution of prompts for an encrypting PIN device, and more particularly, to a method for substitution of prompts for non-PIN entry.

2. Description of the Related Art

Point of Sale (POS) terminals of the type typically used by merchants permit holders of charge cards, credit cards, debit cards, and the like to make electronic payments for services and merchandise quickly and easily. With the advent of stored value cards and other smart card schemes, the use of POS terminals in some form is likely to increase dramatically over the next few decades. Indeed, as the feature set of POS terminals and associated peripheral devices increases, the use of POS terminals may largely supplant or even replace the use of cash and checks in many contexts.

For existing POS terminals used to process PIN (personal identification number) authenticated transactions, there is a need to upgrade the attached encrypting PIN pad devices, the associated peripheral device of the POS terminal, to meet new security requirements. The POS terminals are programmed to use a command set to communicate with the PIN pad device. However, the command set is not designed to work with the PIN pad devices meeting the latest industry standards for security. All prompts displayed by the device to cardholders must be securely stored in the PIN pad device and have been approved and authenticated for loading into the device by business entity responsible for the security of the device. The problem is incurred by upgrading these PIN pad devices and relates to maintaining compatibility with general display commands used by the existing POS terminals to display various messages to the cardholders. The applications resident in the existing terminals are to use general display commands that include the display information as a parameter of the command. The security is exposed to unauthorized use of these commands to instruct a cardholder to enter his PIN at a time when it can be illegally captured in clear text mode.

### SUMMARY OF THE INVENTION

An objective of the present invention is to provide a method for substitution of prompts for an encrypting PIN device. The method basically allows an encrypting PIN device to work with the existing command set by accepting prompts that the device expects to receive and displaying prompts that are the approved substitutes for the received prompts.

To achieve the objectives, the present invention discloses a method for substitution of prompts for an encrypting PIN device. After receiving a general display command, the encrypting PIN device recognizes whether the prompt of the received command corresponds to any of the expected prompts stored in the device. If the received prompt matches an expected prompt, an approved prompt linked to the expected prompt is substituted for the expected prompt, and is displayed by the encrypting PIN device and numeric entry is allowed during the display of this prompt. On the contrary, the received prompt that is not recognized as an expected prompt is displayed but without any capability for numeric entry during the display of the unexpected prompt.

Before all aforesaid steps, each of the expected prompts to be accepted by the encrypting PIN device is linked to one of the approved prompts, and then the prompt loading command for each prompt is cryptographically authenticated. Finally, the authenticated prompt-loading commands are sent to the encrypting PIN device. The device verifies the authentication of each command and stores the prompt if the verification is successful.

### BRIEF DESCRIPTION OF THE DRAWINGS

The invention will be described according to the appended drawings in which:

FIG. 1 is a flowchart of prompt substitution processes in accordance with the present invention; and

FIG. 2 is a flowchart of loading prompts into an encrypting PIN device in accordance with the present invention.

### PREFERRED EMBODIMENT OF THE PRESENT INVENTION

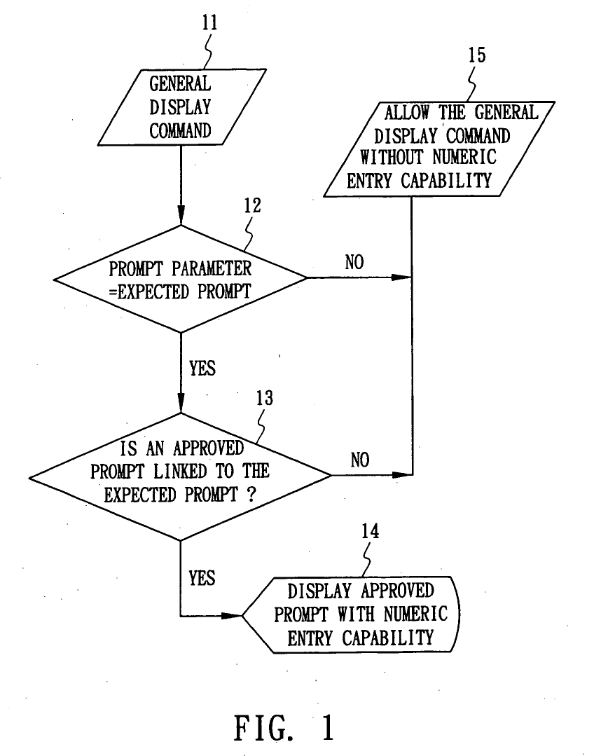

FIG. 1 is a flowchart of prompt substitution processes in accordance with the present invention. Referring to Step 11 and Step 12, after a general display command is input into an encrypting PIN device, the encrypting PIN device checks whether the prompt parameter of the general display command is identical to an expected prompt. The expected prompt means that the encrypting PIN device expects to see such prompts coming in the general display commands sent by a POS terminal or a transaction terminal. Furthermore, the general display command is used to display a prompt on the screen of the encrypting PIN device or the terminal. If the prompt parameter is identical to an expected prompt, Step 13 is the succeeding step to be checked. Otherwise, the general display command is allowed without numeric entry capability, as shown in Step 15. That is, the encrypting PIN device prohibits numeric entry during display if the received prompt fails to match any of the expected prompts.

As shown in Step 13, after the encrypting PIN device recognizes that the received prompt parameter corresponds to an expected prompt, the approved prompt linked to the expected prompt is substituted for the expected prompt. If there is no approved prompt for the expected prompt, the general display command is allowed without numeric entry capability. That is, the encrypting PIN device prohibits numeric entry during display if no approved prompt is linked to the expected prompt. Furthermore, the encrypting PIN device has no display in response to the expected prompt. On the contrary, the screen displays the approved prompt with numeric entry capability, as shown in Step 14.

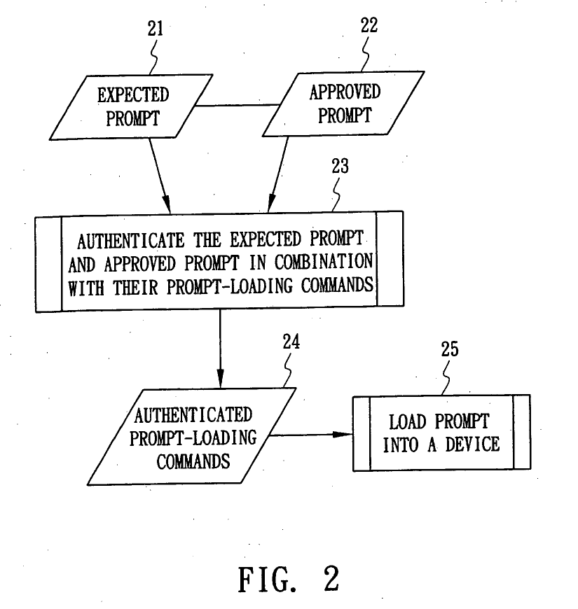

Before all aforesaid steps, all prompts displayed by the encrypting PIN device to the user must be securely stored in the encrypting PIN device and have been approved and authenticated for loading into the same device by an approver, business entity. As shown in FIG. 2, each of the expected prompts accepted by the encrypting PIN device is linked to one of the approved prompts in advance, and then the expected prompt 21 and the approved prompt 22 are authenticated in combination with their prompt-loading commands in Step 23. Finally, the authenticated prompt-loading commands are ready to be loaded into the encrypting PIN device in Step 24 and Step 25.

The above-described embodiments of the present invention are intended to be illustrative only. Numerous alternative embodiments may be devised by persons skilled in the art without departing from the scope of the following claims.

What is claimed is:

1. A method for substitution of prompts for an encrypting PIN device, comprising the steps of:
receiving a general display command from a transaction terminal;
recognizing whether any display prompt information delivered by the received general display command corresponds to one of expected prompts stored in the device.
substituting an approved prompt linked to that expected prompt for the expected prompt; and
displaying the approved prompt.

2. The method for substitution of prompts for an encrypting PIN device of claim 1, wherein the encrypting PIN device prohibits numeric entry during display if the received prompt fails to match any of the expected prompts.

3. The method for substitution of prompts for an encrypting PIN device of claim 1, wherein the encrypting PIN device prohibits numeric entry during display of the approved prompt if no approved prompt is linked to the expected prompt.

4. The method for substitution of prompts for an encrypting PIN device of claim 3, wherein the encrypting PIN device has no display in response to the expected prompt.

5. The method for substitution of prompts for an encrypting PIN device of claim 1, further comprising the antecedent steps of:
linking the expected prompt to the approved prompt;
authenticating the expected prompt and approved prompt in combination with their prompt-loading commands; and
loading the authenticated prompt-loading commands into the encrypting PIN device.

6. The method for substitution of prompts for an encrypting PIN device of claim 5, wherein the linking of the expected prompt and the approved prompt is a link based on the prompt numbers under which they are stored.
